(19) United States
(12) Patent Application Publication
(10) Pub. No.: US 2007/0067487 A1
(43) Pub. Date: Mar. 22, 2007

(54) Communications node

(75) Inventors: Neil Freebairn, London (GB); Roger William Stuart Lewis, Durham (GB)

Correspondence Address: MCDERMOTT WILL & EMERY LLP, 2049 CENTURY PARK EAST, 34TH FLOOR, LOS ANGELES, CA, 90067-3208, US

(73) Assignee: NewNew Networks Innovations Limited

(21) Appl. No.: 10/529,920

(22) PCT Filed: Oct. 4, 2002
(86) PCT No.: PCT/GB02/04499

§ 371 Date: Feb. 6, 2006

(30) Foreign Application Priority Data
Oct. 4, 2001 (GB) 0123862.5

(51) Int. Cl. G06F 15/173

(52) U.S. Cl. 709/238

(57) ABSTRACT

A communications node for establishing a plurality of logically distinct communications links running in parallel through the node to one or more remote nodes, comprises an input switch means, an output switch means, a plurality of communications resources connected between said input and output switch means, said plurality of communications resources including at least first and second communications resources adapted to deliver different communication services including packet-switched and circuit-switched services, control means associated with said input switch means and said output switch means to establish logically distinct links through the node, wherein each said link is configurable to selectively include one of the at least first and second communication resources.

### FIELD OF THE INVENTION

This invention relates to a communications node such as a multiservice switching apparatus and methods of operating communications nodes to perform for example multiservice switching.

Embodiments of the present invention are useful in, for example, chip-to-chip interconnect, board-to-board interconnect, chassis-to-chassis interconnect as well as in traditional network devices, such as LAN hubs and bridges, WAN routers, metro switches, optical switches and routers, wireless access points, mobile base stations and terminals, PDA's and other handheld terminals, wireless or otherwise, as well as other communications applications.

### BACKGROUND OF THE INVENTION

Communications networks can be categorized according to the kind of traffic they are designed to carry, for example voice, video or data. Essential differences in purpose give each of these three kinds of network weaknesses when used for purposes other than they were designed for.

Circuit-switched networks are not designed to facilitate the introduction of new network services. When they were originally designed, the range of services envisaged was limited and the industry had been slow to move on from proprietary standards. Since then SS7 signalling has been introduced, but this operates over a separate packet network. Circuit-switching requires an end-to-end connection to be established before it can be used. This introduces a small but nonetheless significant delay before data can be sent across the connection. Circuit-switching normally employs narrow band links which are unsuitable for many applications, especially those involving video. The term “circuit-switched” and “circuit-switching” used herein relate to switching to facilitate low latency data transfer as is common in the art and should not be construed as limited to original hard-wired circuit-switched connections.

Data networks use packet-switched architectures to enable relatively sophisticated (compared to a telephone) terminal devices such as computers to access asynchronous multipoint-to-multipoint connectivity. The term “packet” used herein will be used to mean a data payload and header which is switched in packet-switching modes. Packets therefore include for example, cells, frames and datagrams. Packet-switched architectures enable multiple data flows to have access to a single set of switching and link transmission resources which gives rise to contention and therefore variability in quality of service. Managing highly variable services to optimise long-term return on investment is complex, risky and costly.

In addition, packet switching requires every packet to be processed, delivering an unnecessary level of network resilience and wasting valuable network resources.

Video networks are traditionally unswitched to provide a limited number of high-bandwidth TV channels to a large number of television terminals. Such a network is unsuitable for interactive communication. Therefore, interactive cable television operators overlay a packet switched network on top of their cable infrastructure, while operators of interactive satellite TV typically use the telephone to provide a backchannel.

A “convergence” network comprising nodes capable of handling multiple services could be less complex, less costly, easier to operate and offer the flexibility of service innovation. However, known convergence networks are based on packet-switched data network architectures.

IPv4 has a packet-switching architecture designed to give users equal access to the switching and transmission resources of a given node. This makes contention for resources a serious problem and accordingly the quality of service that packets receive is uncertain, even highly variable. As a result IPv4 network operators tend either to be a provider of higher cost, higher quality network services by leaving sufficient headroom to be confident that contention and the delays, jitter, packet-loss it introduces will be below thresholds their users demand, or to be a provider of lower-cost, lower quality network services in larger volumes by operating the network close to its maximum throughput. This is constrained only by the maximum delays, jitter, and packet-loss that users will accept.

By design and for simplicity, IPv4 routers are stateless and therefore are not able to employ efficient processing techniques that require the router to be set up, such as pre-transmission switch set up, as used in circuit-switched networks, ATM networks etc, and process each header independently of every other, wastefully expending scarce network processing resources.

In standard serial transmission a packet's bits are sent contiguously. Variable packet lengths therefore introduce jitter also known as interpacket delay variation. This is variability in the duration of the gap between the arrival of one packet and the arrival of the next. Speed of processing can reduce but not eliminate this variability and the threshold of acceptability is continually being lowered by advancing user expectation.

Another drawback with IPv4 is that its headers are not structured to be easily readable for high-speed processing.

A number of overlay architectures and associated protocols have been developed to enable differentiated services to be offered in an IP network by enabling router resources to be differentially applied to particular classes of packets. This enables contention to be managed. Examples are IntServ, DiffServ, and MPLS. New protocols are introduced to enable the services to be accessed and the IP routers re-designed to enable these services to be delivered. Packets are class marked at the point of entry into the network (or earlier) so that the routers know which new service elements to provide. The introduction of a service differentiation architecture into IPv4 enables network managers to control the relative quality of service that different packet classes receive but the scope for differentiating among packet classes is not adequate to differentiate services between individual end users. Accordingly, packets will continue to contend for resources and end users will continue to experience service variability.

IPv6 is a major architectural upgrade to IPv4 which introduces a number of important enhancements to IPv4, including Mobile Internet Protocol, automated address configuration, improved security and routing, and a much larger address base. IPv6 meets service differentiation challenges by introducing into the header a 20-bit flow label which enables the application of packet processing resources to be differentiated down to individual application data flows. IPv6 also reduces the complexity of header processing by fixing the header structure. This means processes can extract information from a predetermined position within the header. IPv6 is different enough from IPv4 that implementing it entails significant costs, risks and challenges. This has been a serious hindrance to its adoption.

ATM is a complete set of networking protocols. ATM implements internetworking through conversion protocols called “adaptation layers”. These enable specific kinds of network traffic (e.g. IP traffic) to be carried transparently across multiple interconnected ATM networks. ATM delivers service differentiation through virtual circuits which enable switching resources to be dedicated to appropriately marked traffic along a path across an ATM network. The fixed small size and structure of ATM cells enables switching of packets using a virtual circuit identifier to be achieved at high speeds, and with very low jitter.

However, the small payload (48-bytes per cell) entails:
[symbol] many more packets per megabyte than IP or Ethernet
[symbol] high packet processing rates for a given bandwidth
[symbol] much more segmentation and reassembly of larger packets received from higher network layers

ATM also offers many sophisticated features suitable for large, high speed commercial networks. Network management and network equipment are correspondingly both more complex and more costly for ATM than for IP.

These drawbacks have limited the adoption of ATM largely to high-speed backbone networks, while simpler and cheaper IP and Ethernet networks dominate elsewhere.

Accordingly, known multiservice architectures bring existing architectural constraints to convergence of voice, video and data networks. There has been a corresponding failure to harness the strengths of independent network types in the multiservice alternatives disclosed to date.

### SUMMARY OF THE INVENTION

The present invention seeks to provide an improved communications node and methods of operation thereof.

According to an aspect of the present invention there is provided a communications node for establishing a plurality of logically distinct communications links running through the node contemporaneously to one or more remote nodes, the communications node comprising:
input switch means;
output switch means;
a plurality of communications resources connected between said input and output switch means, said plurality of communications resources including at least first and second communications resources adapted to deliver different communication services including packet-switched and circuit-switched services;
control means associated with said input switch means and said output switch means to establish logically distinct links through the node, wherein each said link is configurable to selectively include one of the at least first and second communication resources.

According to another aspect of the present invention there is provided a communications node for receiving at least one input signal comprising a plurality of components, each said component comprising part of a logical link over a portion of a communications network, the communications node comprising:
ingress means for receiving said at least one input signal;
egress means for outputting at least one output signal comprising one or more components of said input signal;
one or more signal processing means connected between the ingress means and egress means, for receiving components of said at least one input signal and processing said components in accordance with a predetermined communications process;
first switching means configurable to selectively cause a signal output from said ingress means to bypass one or more of said signal processing means en route to said egress means;
second switching means configurable to direct signals output from said signal processing means to said egress means.

According to another aspect of the present invention there is provided a communications node for receiving and transmitting signals comprising sets of signal components transmitted at intervals, wherein a set comprises a number of signal components partitioned from one another and wherein concatenated signal components in adjacent sets establish a number of logical links over a portion of a communications network, said node comprising:
input switch means;
output switch means;
control means connected to said output switch means and programmable to cause selected ones of the partitioned signal components of a set to be aggregated, such that said aggregated signal components define an aggregated logical link having a bandwidth corresponding to a predetermined multiple of the signal component bandwidth.

Advantageously preferred embodiments are universal, interoperating with packet switched and circuit switched architecture, and is applicable to layer 2+ protocols (including ATM, Ethernet 802.3 and 02.11, IPv4 and IPv6, MPLS) and system interconnect standards (such as Infiniband, PICMG 2.16 and 2.17).

Preferred networks can instantly provision dedicated end-to-end paths that can achieve 100% efficiency, while traditional packet switched networks often waste more than 50% of their theoretical throughput managing congestion.

Preferred nodes handle QoS internetworking at layer 1, reducing requirement for network packet processing—policing, routing, scheduling, protocol conversion, tunneling, segmentation and reassembly, header modification, checksum recalculation, etc.—which introduces cost, complexity and latency.

Preferred nodes enable a common physical network to be reconfigured on-the-fly into logically distinct virtual networks that can have distinct topologies.

Preferred node virtual networks can use and isolate distinct bearer services, enabling a common physical network to support, for example, ATM+IP, IPv4+IPv6, Ethernet LAN+IP WAN, or even packetized and unpacketised traffic.

Preferred nodes offer a single common migration path to convergence for all network operators.

Preferred nodes provide a scalable foundation for multiservice switching systems.

Preferred nodes guarantee low-latency where it is required.

Preferred nodes permit per-hop latency soft-configurable, practically around 1 ms.

Preferred nodes guarantee bounded jitter (interpacket delay variation).

Preferred nodes permit in-order delivery of packets.

Preferred nodes permit dedicated end-to-end paths (zero congestion).

Preferred nodes offer unpacketised streaming data which can be transported, enabling significant efficiency gains.

Preferred nodes enable Ethernet in the LAN and UNA-enabled IP in the WAN and MAN will perform significantly better than ATM in these environments and at lower cost.

### BRIEF DESCRIPTION OF THE DRAWINGS

An embodiment of the present invention will now be described, by way of example only, with reference to the accompanying drawings, in which:

FIG. 1 is a schematic diagram of a preferred communications node for multiservice switching which embodies the present invention;

FIG. 2 is a more detailed view of the communications node of FIG. 1;

FIG. 3 is a schematic diagram of a first synchronous asynchronous time-slot interchange (SATSI) stage in the node of FIG. 1;

FIG. 3A is a schematic diagram illustrating the switching of synchronous and asynchronous signals through an exemplary multiservice switching node;

FIG. 4 is a flow diagram illustrating loading of a switching buffer in a synchronous mode of operation of the SATSI stage of FIG. 3;

FIG. 4A is a flow diagram illustrating loading of a switching buffer in an asynchronous mode of operation of the SATSI stage in FIG. 3;

FIG. 5 is a flow diagram illustrating an asynchronous mode of operation of the SATSI stage of FIG. 3;

FIG. 6 is a flow diagram illustrating a packet-switching mode of operation of the SATSI stage of FIG. 3;

FIG. 7 is a flow diagram illustrating a time-slot interchange switching scheme applied to the time-slot interchange switching stage of FIG. 3;

FIG. 8 is a schematic diagram of a network illustrating how preferred embodiments converge different networks through multiservice nodes to achieve extended circuit switched channels and/or packet channels through a multiservice network.

### DETAILED DESCRIPTION OF PREFERRED EMBODIMENTS

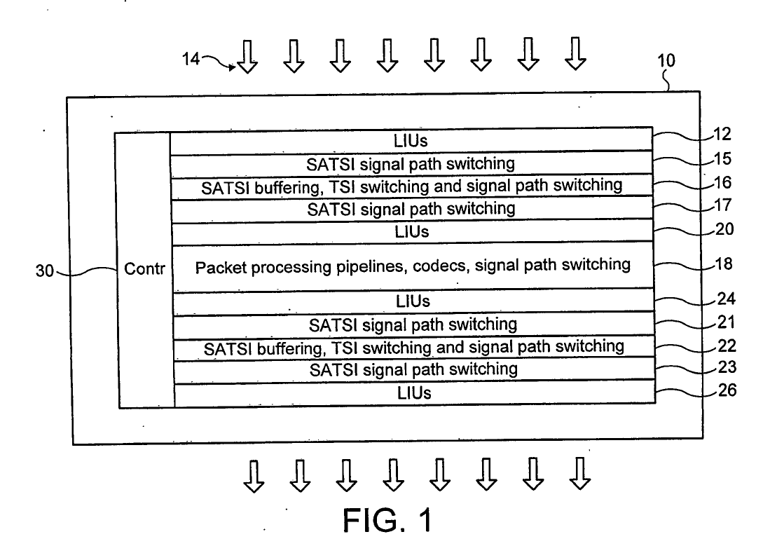

With reference to FIG. 1, the preferred embodiment is a communications node 10 for multiservice switching. The node 10 has an ingress stage having a number of physical communications interfaces in the form of multiple line interface units 12 for receiving a plurality of signals 14. At least one of these interfaces, and usually several of them, employ a synchronous transmission protocol, for example H.110. Others of the physical communications interfaces are asynchronous. The configuration of nodes embodying the present invention in respect of for example the numbers of synchronous and asynchronous signal paths is arbitrary and will depend at least in part on the application. The configuration may also be dynamic in that one or more of the signal paths of the node has synchronous and asynchronous modes of operation.

The received signals 14 are on discrete paths, and each signal is either synchronous or asynchronous. In this example, each synchronous signal can be regarded as a plurality of time-division multiplexed time-slots in succession carrying traffic of various kinds, including packets of different network protocols—for example IP, ATM, Ethernet—and unpacketised data, for example PCM voice. Each asynchronous signal may be regarded as a plurality of statistically multiplexed packet-switched services.

The line interface units 12 are connected to a first signal path switching stage 15. This stage is arranged to switch signals either into a first Synchronous Asynchronous Time-Slot Interchange SATSI stage 16, which stage 16 includes buffering, and both Time Slot Interchange TSI and signal path switching, or a second signal path switching stage 17. The SATSI stage 16 is arranged to switch the contents of time slots of the independent signal paths between line interface units 12 and 20. The line interface units 20 are connected to a core processing stage 18 providing packet processing, signal processing and direct connections, which stage 18 will be explained in more detail hereinafter. The core processing stage 18 is connected via the line interface unit 24 to a third signal path switching stage 21. Like stage 15, this stage is arranged to switch signals either into a second Synchronous Asynchronous Time-Slot Interchange stage 22 including buffering, and both TSI and signal path switching, or a fourth signal path switching stage 23. A further bank of line interface units 26 form an egress stage adjacent to the fourth signal path switching stage 23.

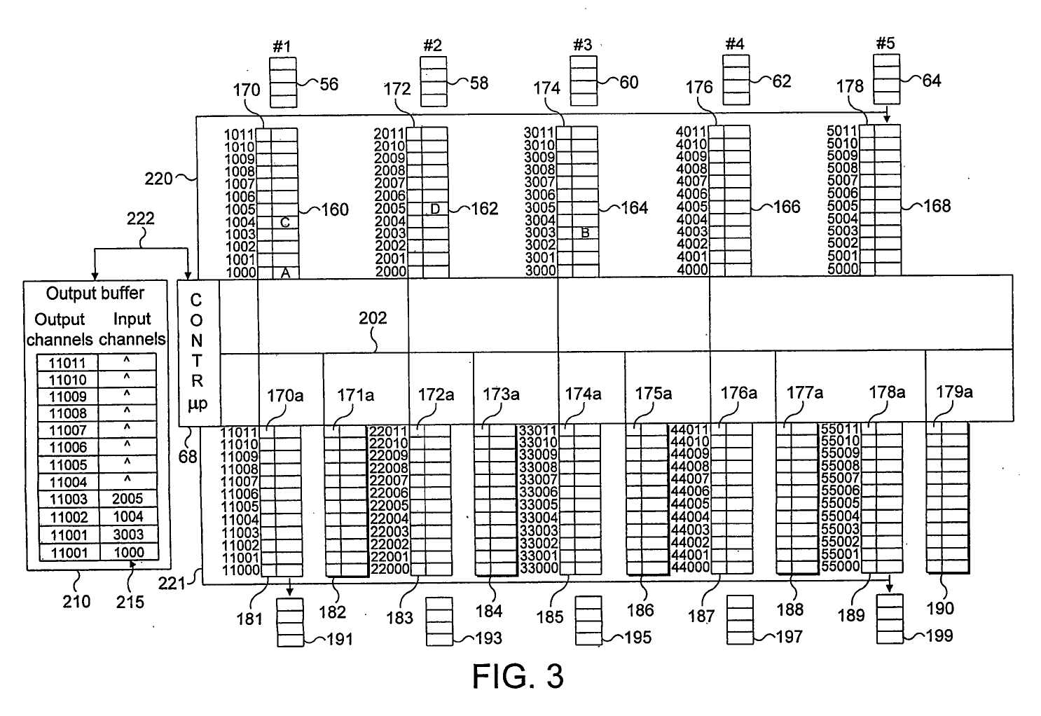

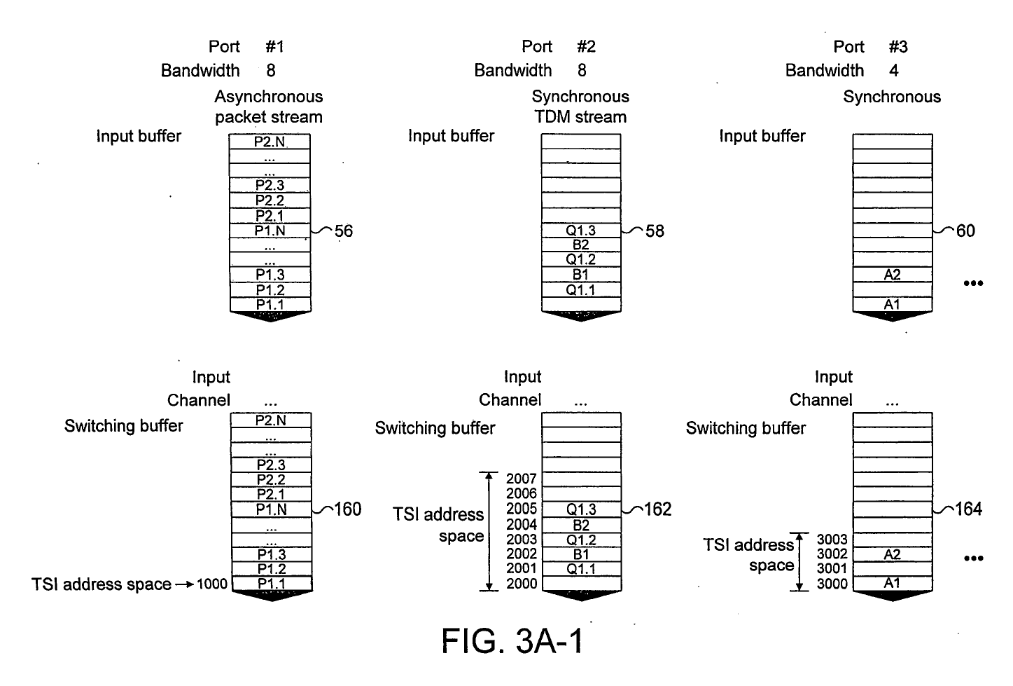

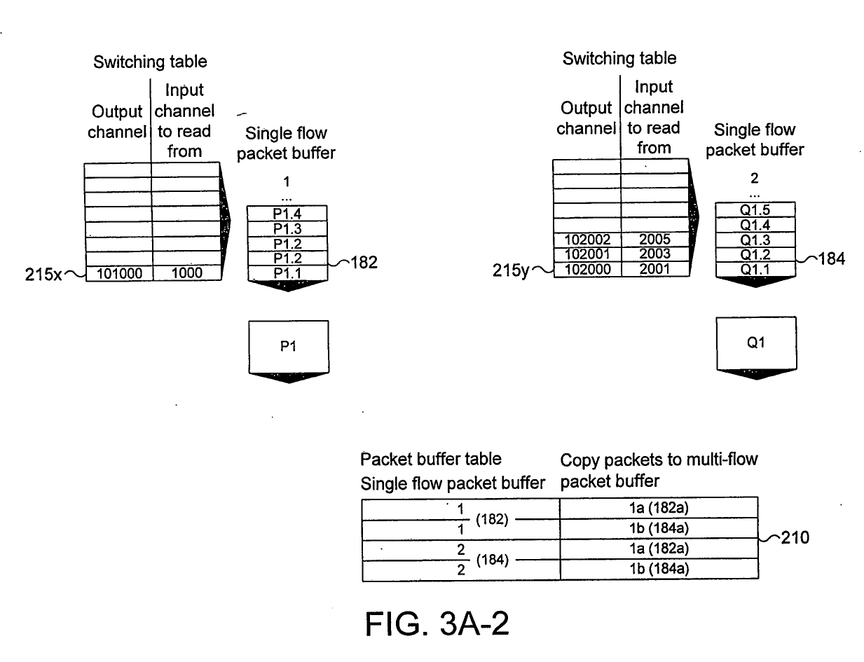

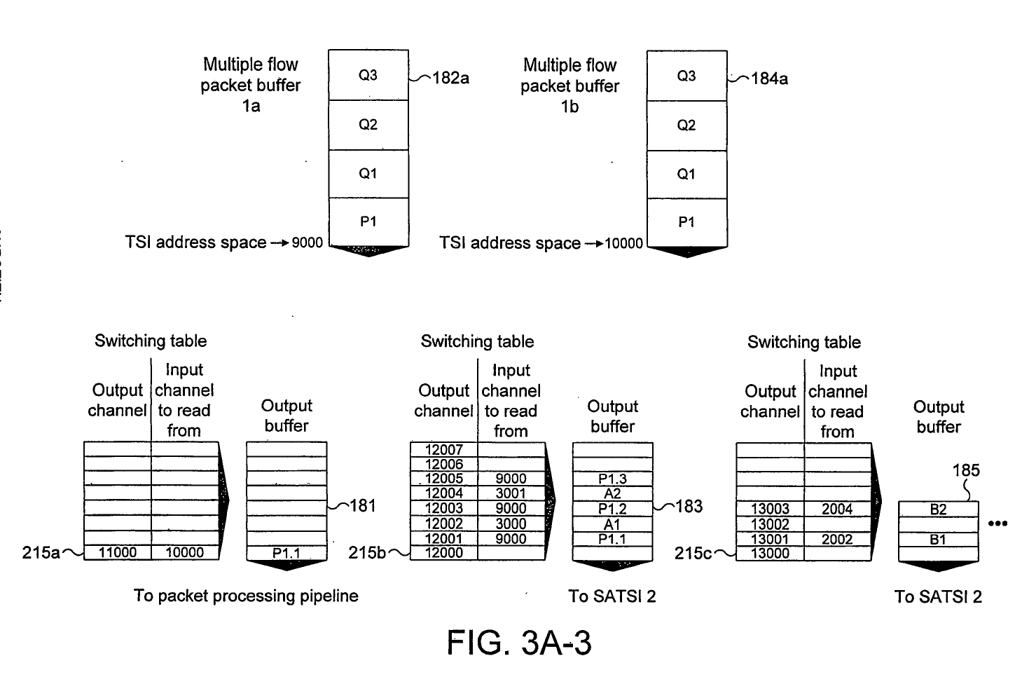

The internal components and modes of operation of the SATSI stages 16 and 22 will be described in more detail hereinafter with reference to FIG. 3.

The node control circuitry 30 includes node resource controllers among other control functions. The node's software and hardware may be configured by sending instructions using standard network protocols to protocol handlers, implemented either in software running on the node or in hardware. Configuration is achieved by known means, for example by changing register values stored in memory shared with hardware.

The node 10 enables bundles of channels in a physical link bandwidth to be programmably aggregated and disaggregated by multiplexing, demultiplexing and buffering. This enables a single physical link to function as a multiplicity of logical links of various desired bandwidths operating in parallel. Physical links can therefore simultaneously support a plurality of logical links collectively carrying a multiplicity of different traffic types. Signals are transmitted onto logical links via buffers, which the switch fabrics transfer cell-by-cell to the appropriate bundle of output channels.

At each node any of the logical links can be independently either circuit-switched by the SATSI stages, or demultiplexed via packet buffering and switched into one of the packet processing pipelines that is appropriate to the traffic type, for example a packet switching stage of Ethernet, ATM, IP, IP over ATM, IP over Ethernet, or a signal processing stage for unpacketised data, such as a decoder for PCM voice, or for MPEG-4 video.

Synchronous transmission is based on communication in frames, time slots, and cells. A cell is the minimal unit that can be transmitted or received, for example 8 bits for a PCM voice telephony network. A time slot is the duration of transmission for a single cell at a given bandwidth. For a given cell size, time slot duration varies with bandwidth as follows:
time slot duration=cell size/bandwidth

Switching of a cell needs to be completed within a single time slot.

A channel is the aggregate transmission capacity of a given time-slot within a frame (explained below). For example, the bandwidth of a unidirectional channel for PCM voice telephony is 64 kbps.

A frame is a block of cells or time-slots associated with a plurality of distinct channels, for example 512 64 kbps channels, which would have an aggregate bandwidth of 32 Mbps. The start and end of a frame and the channels within a frame are signalled by clock pulses. Nodes which use a common reference clock for timing form a synchronous network.

Channel bandwidth, time slot duration and cell size are related by the formula
channel bandwidth=cell size/time slot duration

Given two of these parameters, the third is therefore determinable.

Preferred networks can therefore be characterised by frame length, channel bandwidth, and cell size.

For a given port bandwidth, larger cells and higher channel bandwidth reduce both the speed at which switching needs to be performed, as there are few switchable cells per frame, and the amount of switching information that needs to be stored in node memory, as there are fewer switchable channels to keep track of.

For example, a 1 Gbps link could carry over 16 million 64 kbps voice channels (each with a cell size of 8 bits and a time slot of 125 microseconds), but managing this number of links is complex. Typically, a switch of this capacity would be located at a point in the network where the number of connections is small, and therefore large groups of these calls are switched to and from the same nodes. This permits many low-bandwidth channels to be multiplexed into few high-bandwidth channels. A 1 Gbps link could be multiplexed into just 32 32 Mbps channels.

Also, input ports in synchronous mode buffer a complete frame ahead of switching, and longer frames therefore entail more latency.

This relationship of frame lengths, cell sizes and channel bandwidths only applies to synchronous links. It does not apply to asynchronous packet-switched links. For example the node can connect to Ethernet networks at 10 Mbps/100 Mbps/1 Gbps/10 Gbps.

The node's clock can be configured to generate timing for frames with an arbitrary number of channels.

The SATSI employs four kinds of buffer, explained in more detail hereinafter. Input buffers receive cells from line interface units. Switching buffers receive data cell-by-cell in asynchronous mode and frame-by-frame in synchronous mode. Single-flow packet buffers receive a cell at a time during the SATSI time-slot interchange process. Single-flow packet buffers serve to buffer cells and forward valid packets of a particular packet protocol, for example Ethernet 802.3 or IP, to one or more associated multiple-flow packet buffers, discarding packets if they are invalid. Single-flow packet buffers are not tied to physical ports—at any instant there may be many more single-flow packet buffers than physical ports.

Multiple-flow packet buffers aggregate (statistically multiplex) packet streams from single-flow packet buffers. Multiple-flow packet buffers are similarly not tied to physical ports—at any instant there may be many more multiple-flow packet buffers than physical ports. Their leading cell is an input channel addressable by the SATSI time slot interchange stage.

Multiple-flow packet buffers operate prioritization and discard policies appropriate to their specific packet protocol. For example, if the buffer is full and a packet is copied to it, the packet may be discarded or other packets may be discarded in favour of it. Also, the packet may be queued elsewhere than at the back, for example, to prioritize it over less time-sensitive packets.

Packets are forwarded onto logical links by means of the packet switch mode of the SATSI, described hereinafter.

Signal streams of any traffic type can be circuit-switched between any two nodes in a network of preferred nodes and can be switched into any of the available packet processing or signal processing pipelines at any node. Unpacketised data is carried end-to-end on one or more logical links that are circuit-switched at all intermediary nodes and the last logical link in the sequence terminates in an appropriate signal processing stage. Packetized data streams can be carried along any combination of circuit-switched logical links and packet-switched logical links, and where each packet switched logical link ends the data is switched into a packet processing pipeline of the appropriate type.

Within a network of preferred nodes with appropriate processing pipelines, this enables network layer packets, for example 1P, to be transmitted and processed without need for a link layer, as defined in the traditional Open Systems Interconnection OSI reference model.

It also enables packets to access established logical links without first having to set up new ones. The preferred node therefore enables services to be provided which flexibly combine features of packet switching, such as “always-on” transport, resilient routing, with features of circuit-switching, such as low latency and security.

It also enables a single physical network to support a multiplicity of virtual networks operating otherwise incompatible network protocols, such as ATM with IP, or IP with Ethernet.

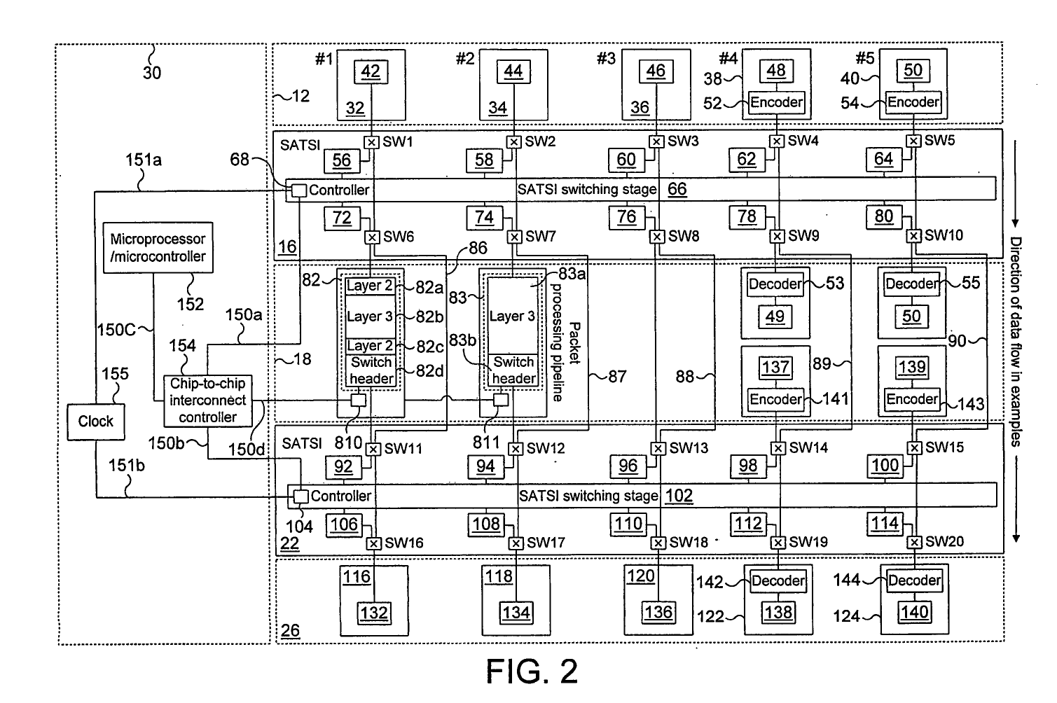

FIG. 2 illustrates parts of the node of FIG. 1 in more detail, in particular components of the line interface stages 12 and 26, the SATSI buffering and switching stages 16 and 22, core stage 18 and the node control circuitry 30. For simplicity intermediate line interface units 20 and 24 are not shown on FIG. 2.

The line interface stage 12 comprises a plurality of line interface units 32-40, each providing an ingress port for a different input path #1-#5 In this example, selected ones of the line interface units 38,40 include encoder circuitry 52,54 and decoder circuitry 53,55 for specific types of communications traffic, such as unpacketised voice and video data streams.

The respective communications paths #1-#15 are switchable by signal path switches SW1-SW5 either to input buffers 56-64 of the SATSI stage 16, or direct to the signal path switches SW6-SW10, which are set up to switch the appropriate input line according to the set up for switches SW1-SW5. The SATSI stage 16 comprises the SATSI switch fabric consisting of further buffer circuitry, multiplexing circuitry and switching tables to be described hereinafter with reference to FIG. 3, and associated control circuitry 68. SATSI control circuitry 68 controls the switching fabric 66 such that predetermined cells of the signals on the input paths #1-#5 are placed in the desired sequence in selected ones of the SATSI output buffers 72-80.

The output buffers 72-80 of the SATSI stage 16 are connected to signal path switches SW6-SW10 for switching their contents between a packet processing pipeline 82,83, decoder circuitry 53,55, or a direct connection 86-90 through the node 10. Packet processing pipelines 82,83 can be seen on FIG. 2 disposed between signal path switches SW6-SW7 of the first SATSI stage 16 and signal path switches SW11-SW12 of the second SATSI stage 22. Direct connections through the node can be seen linking signal path switches SW6-SW10 of the first SATSI stage 16 to signal path switches SW11-SW15 of the second SATSI stage 22. The switches SW11-SW12 are set up to switch the appropriate input line according to the set up for switches SW6-SW10.

The second SATSI stage 22 comprises elements corresponding to those of the first SATSI stage 16, namely input buffers 92-100, signal path switches SW11-SW12 and SW16-SW20 (mentioned above) a SATSI switching fabric 102, of further buffers, multiplexing circuitry and switching tables, output buffers 106-114, and control of control circuitry 104. Switches SW16-SW20 are set up to switch the appropriate input line according to the set up for switches SW11-SW15. The outputs of switches SW16-SW20 are connected to a corresponding plurality of line interface cards 116-124. In this example, line interface cards 122 and 124 are provided with encoder/decoder circuitry 142,144 specific to predetermined traffic types.

Interconnects 150A-150C connect the SATSI control circuits 68 and 104 to a microprocessor controller 152 through a chip-to-chip or board-to-board interconnect mechanism device 154, such as a PCI bus, or through shared memory, as for example in memory mapped I/O.

Interconnects 151A-B connect the clock to SATSI control circuitry 68 and 104.

The node initializes by discovering its resources, for example the SATSIs, the packet processing pipelines, codecs, etc., and their properties, for example port bandwidth and transmission timing (synchronous or asynchronous), and then configuring them according to any pre-established set of instructions.

Asynchronous links have a single unpartitionable channel and can support only a single logical link carrying packetized data. They therefore have a single entry in their switching tables as will be explained hereinafter. At initialization, each half-duplex unidirectional link is also configured as a single logical link, one hop long, packet switched into a packet processing pipeline for a default network signalling and control protocol, for example IP. The switching tables are therefore initialized with a single entry.

This enables the nodes to communicate with each other using standard network protocols to share appropriate information about their resources, including details of the logical links they have available, such as what network addresses they connect to. This sharing of information occurs whenever relevant changes occur so that nodes in the network are kept up to date about the state of other nodes. Other node resources may then be configured to partition physical links into logical links and to switch logical links to appropriate processing stages.

In this way, the control network can be partitioned to use, for example, a slice of the available physical link bandwidth and a single packet processing pipeline per node (which it may share with other traffic). Node resources can then be configured to also provide connectivity and packet processing for virtual networks, even ones that use protocols incompatible with the default network protocol. Examples of network protocols for which the node might provide processing include but are not limited to IPv4, IPv6, SNMP, ICMP, TCP, RSVP, SIP, H323, Q931, Ethernet IEEE 802.3, ATM, SS7.

FIG. 3 illustrates the components and exemplary functions of the first SATSI switching stage 16. Although the reference numerals on FIG. 3 apply to the first SATSI stage 16, for clarity, the second SATSI stage 22 has corresponding components and the same manner of operation, mutatis mutandis.

At the top of FIG. 3 the SATSI input buffers 56-64 each supply a corresponding switching buffer 160-168. Discrete address spaces within each of the switching buffers 160-168 are addressable by means of the addressing circuitry 170-178 associated with each of the switching buffers and connected via the multiplexing circuitry 202 to the control circuitry 68. The control circuitry 68 has access to switching information 210. In this embodiment, the switching information 210 is in the form of a plurality of switching tables, one switching table being associated with each of a plurality of buffers 181-190. Of these buffers 181, 183, 185, 187, 189 are output buffers connected to corresponding line interface units 191-199, and 182, 184, 186, 188, 190 are packet flow buffers available for use by control circuitry in asynchronous mode and packet switch mode to maintain single-flow and multiple-flow packet buffers. For clarity, FIG. 3 shows only a portion 215a of the switching information 210 associated with the first output buffer 181. In practice, each output buffer 181, 183, 185, 187, 189 would have associated with it a switching table defining for each address space within it a source address space within one of the switching buffers 160-168, or one of the packet flow buffers 182, 184, 186, 188, 190. The uses of packet flow buffers 182, 184, 186, 188, 190 and associated tables are described hereinafter with reference to FIG. 3A.

Discrete address spaces within each of the buffers 181-190 are individually addressable by means of addressing circuitry 170a-179a associated with each said buffer. The addressing circuitry 170a-179a is connected through the multiplexing circuitry 202 to the switch control circuitry 68. The line interface unit 191-199 are disposed between the first SATSI stage 16 and the core stage 18 of the node.

The input channel field of each switching table is programmed with the input channel addresses from which the next cell is to be read for each output channel in turn. The same input channel may appear more than once in the switching tables.

This enables an input channel to be switched to multiple output channels at the same time, providing a means of replicating input to output for the purposes of multicasting and any casting etc.

Output channels that are unused are marked as such to permit processes wishing to alter the switching tables to determine whether a channel is in use or not. Only if a channel is not in use does the control circuitry 68 allow an output channel entry in a switching table to be amended.

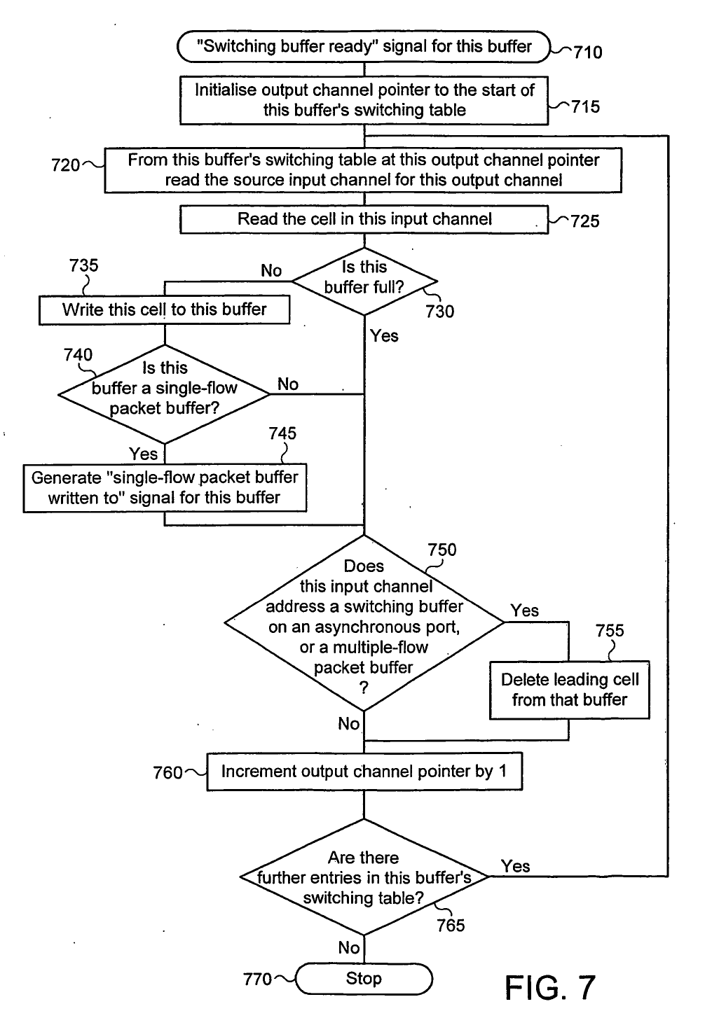

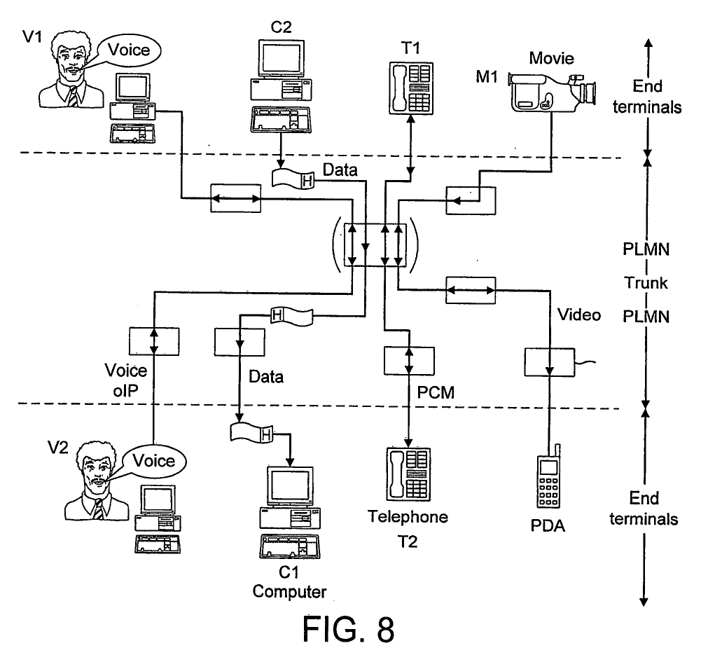

In the example of FIG. 3, signal path #1 is regarded as a synchronous signal path, and the SATSI port is in synchronous mode. The start of the frame is signalled across the network by the frame pulse. Control circuitry 68 detects the frame pulse via bus 220 and, in response, causes the contents of the input buffer 56 to be copied into the corresponding switching buffer 160. For synchronous signals, the SATSI stage 16 thus switches the contents of an entire frame within the frame's duration. For asynchronous signals, the SATSI stage 16 buffers packets in multiple-flow packet buffers and switches the buffers' leading cells, deleting the leading cell each time one is switched (see FIG. 7). The switching information 210 controls the sequence of filling of each buffer 181-190.

According to the convention adopted for the purposes of FIG. 3, input channels beginning with 1 form part of signal path #1, input channels beginning with numeral 2 form part of signal path #2 and input channels with 3 form part of signal path #3 . . . and so on. With reference to the switching table 215a relating to output buffer 181, the first address space (channel) 11,000 of the output buffer 181 is designated to receive the contents A of input channel 1000. The second address space 11,001 of output buffer 181 is designated to receive the contents B of input channel 3003. The third address space 11,002 of buffer 181 is designated to receive the contents C of input channel 1004. The fourth address space 11,003 of the output buffer 181 is designated to receive the contents D of input channel 2005 and so on, until the table entry relating to the last space of the output buffer is reached.

Although not shown explicitly herein, the switching table 215a could also designate input channels from input buffers 166, 168 of signal paths #4 an #5, and from packet flow buffers 182, 184, 186, 188, 190.

It will thus be apparent how all of the address spaces in each output buffer 181, 183, 185, 187, 189 are populated with the content of the various input channels, which represent address spaces in input buffers and packet-flow buffers according to the switching information 210 in the course of one frame duration.

Thus SATSI switching stages 16,22 are able to receive, switch and transmit a mixture of synchronous and asynchronous inputs, including packet streams.

Each SATSI stage 16,22 therefore has three modes of operation:
(i) a synchronous mode which enables cells in time-slots in frames within signals arriving on different input paths to be interchanged. This enables multiple circuited switched links on partitioned physical link bandwidth;
(ii) an asynchronous mode which enables logical links carrying packets to be repacketised via single flow packet buffers and statistically multiplexed into one or more multiple-flow packet buffers for forwarding onto outbound logical links or into packet processing pipelines; and
(iii) a packet switching mode which enables packets that have been processed through a packet routing algorithm and had a switching header prepended to be forwarded to the appropriate set of outbound logical links via the appropriate set of multiple-flow packet buffers.

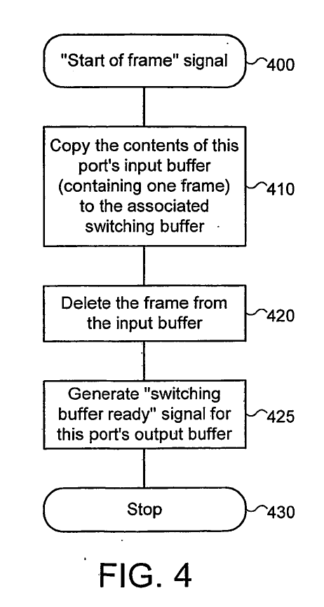

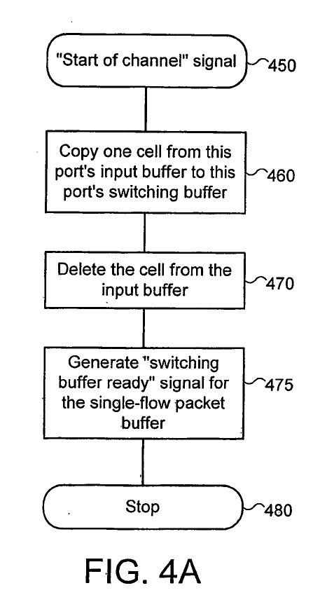

In general, but not exclusively, paths through the first SATSI stage 16 operate in modes (i) or (ii), whereas paths through the second SATSI stage 22 operate in modes (i) or (iii). The modes (i), (ii), (iii) above are described in more detailed with reference to FIGS. 4, 5 and 6 respectively.

In FIG. 3A, three exemplary signals are shown arriving at ingress ports on paths #1, #2 and #3 of the node. These ports are referred to herein as ports #1, #2 and #3 accordingly. The signal on path #1 is asynchronous, while the signals on paths #2 and #3 are synchronous. Therefore in this example port #1 of the SATSI is in asynchronous mode, and ports #2 and #3 are in synchronous mode. SATSI TSI switching, signal path switching, and packet buffering enable core processing stages, including packet processing pipelines, to process data flows carried from any inbound logical link. The dotted lines indicated by reference numeral 61 are to indicate that other ports would be present but are not shown here.

At SATSI port #1, cells P1.1, P1.2 . . . P1.n of the packet stream arrive at the input buffer 56 and are transferred as they arrive cell-by-cell to the switching buffer 160 of the port. On ports #2 and #3, cells of the synchronous stream arrive and are buffered in input buffers 58,60 until the “start of frame pulse” is detected, when the contents of the input buffers 58,60—an entire frame of cells—is transferred to the switching buffers 162,164. The switching buffers 160-164 thus buffer the contents of the input channels and are addressable via the switching tables, as described hereinbefore with reference to FIG. 3.

Switching table 215a is programmed such that output channel 11000 receives cells from input channel 10000, which is the address of the leading cell of multiple-flow packet buffer 184a, maintained to permit packets to be multiplexed onto this outbound logical link. The contents of these output channels are written to the output buffer of egress port #1 for transmission via line interface units 191.

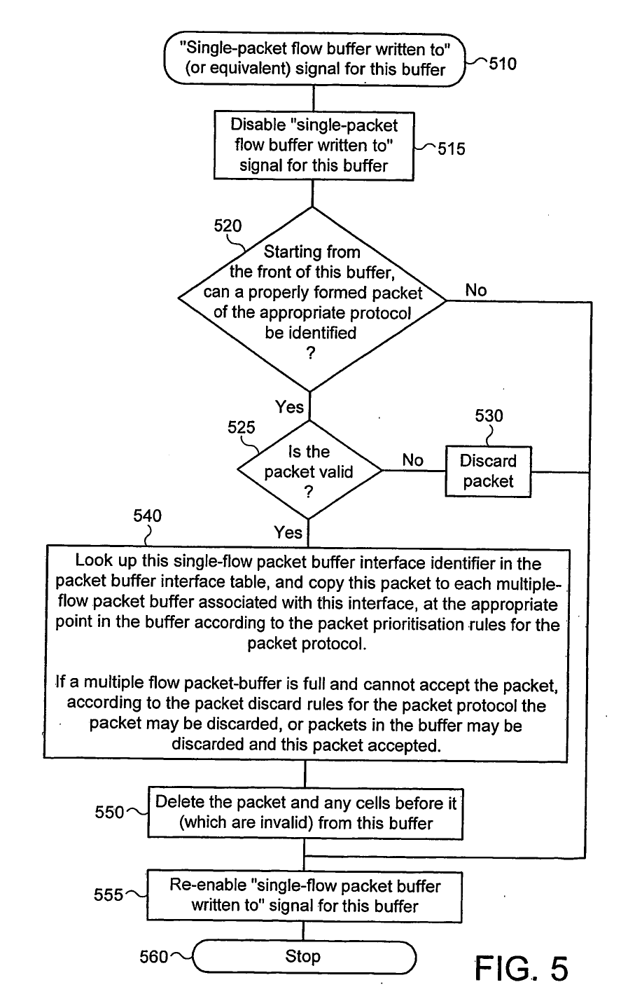

Switching table 215× is programmed such that output channel 101000 receives cells from input channel 1000, which is the address of the front of the switching buffer 160 for the signal arriving at ingress port #1. The cells of this output channel are buffered in a single-flow packet buffer 182 operating in asynchronous mode (see FIG. 5), which repacketises the contents according to the specific packet protocol. Control circuitry 68 looks up this buffer in the packet buffer interface table 211, described in more detail hereinafter, and copies packets issuing from this buffer to the multi-flow packet buffers 182a, 184a. Packets P1 P2 . . . and so on are thus copied to multiple-flow packet buffers 1 and 2 referenced by numerals 182 and 184 respectively.

Switching table 215b is programmed such that output channels 12001, 12003, 12005 receive cells from input channel 9000, which is the address of the leading cell of multiple-flow packet buffer 182a maintained to permit packets to be multiplexed onto this outbound logical link. Switching table 215b also dictates that output channels 12002, 12004 receive cells from input channels 3000,3001, which represent the inbound logical link within the signal on path #2 carrying stream A, composed of cells A1, A2 etc. The contents of these output channels are written to the output buffer 183 of egress port #2 for transmission via the line interface unit 193.

Switching table 215b is programmed such that output channels 102000-102002 receive cells from input channels 2001, 2003, 2005, which represent the inbound logical link within signal #2 carrying packet stream Q, composed of packets Q1, Q2 . . . Qn. The packet Q1 is, in turn, composed of cells Q1.1, Q1.2 . . . Q1.n. The corresponding output channel is buffered in a single-flow packet buffer 184 operating in asynchronous mode (see FIG. 5), which repacketises the contents of the buffer according to the specific packet protocol. Control circuitry 104 looks up this buffer in the packet buffer interface table 210, described in more detail hereinafter, and copies packets issuing from this buffer to the multi-flow packet buffers 182a, 184a. Packets P1, P2, etc are thus copied to multiple-flow packet buffers 1 and 2.

Switching table 215c is programmed such that output channels 13001, 13003 receives cells from input channels 2002, 2004, which represent the inbound logical link within the signal on #2 carrying stream B, composed of cells B1, B2 etc. The contents of these output channels are written to the output buffer of egress port #3 for transmission via the line interface unit 195.

Thus, a packet stream (O) carried on a logical link within a synchronous signal arriving at ingress port #2 is demultiplexed and packetized, and the packets are buffered along with those from a packet stream (P) carried on an asynchronous signal arriving at ingress port #1. The resulting statistically multiplexed packet flow is multiplexed onto two outbound logical links (via two multiple-flow packet buffers), one a part of port #2's output signal and the other the whole of port #1's output signal. In addition, the contents of two logical links with identical bandwidths are swapped.

The switching fabric and technique described having regard to FIG. 3 is used in all three modes of operation of the SATSI 16 and the SATSI 22 as will be explained with reference to FIGS. 4 to 6. For clarity only the reference numerals applying to the first SATSI stage 16 are used here. However, all three modes can be employed by either of the SATSI stages 16 or 22.

From FIGS. 3 and 3A it will be apparent that for each inbound logical link carrying a packet flow that is to be demultiplexed for processing by a packet processing pipeline at this node, control circuitry 68,104 creates a single-flow packet buffer, which operates in asynchronous mode. And for each outbound logical link that is to carry a multiplexed packet flow, control circuitry 68,104 creates a multiple-flow packet buffer, and associates it with one or more packet flows from single-flow packet buffers via the packet buffer interface table.

Each single-flow packet buffer can thus be interfaced to one or more multiple-flow packet buffers by programming the packet buffer interface table with an appropriate identifier for the buffer against appropriate identifiers for the appropriate multiple-flow packet buffers. This enables a multiplicity of packet flows to be statistically multiplexed into a single flow, for transmission to a packet processing pipeline or via a logical link to another node.

In addition, the routing information used by packet processing pipelines to select and identify the path for packet forwarding may use interface identifiers which correspond to multiple entries in the packet buffer interface table. This enables packet flows buffered in multiple-flow packet buffers to be replicated to a multiplicity of outbound logical links.

FIG. 4 illustrates the buffer loading process that is performed when a path through the SATSI is operating in synchronous mode. At step 400 the “start of frame” signal generated by the clock 155 is detected by the control circuitry 68, and the process is triggered to start. At step 410, the control circuitry 68 causes the content of this port's input buffer 56-64, which will be a frame of cells, to be copied to this port's switching buffer 160-168. At step 420 control circuitry 68 deletes the frame of cells from the input buffer 56-64. At step 425 control circuitry 68 generates a “Switching Buffer Ready Signal”, which triggers the SATSI time-slot interchange switching process (see FIG. 7) to start for this port's output buffer. Control then stops the process until it is triggered by the next “start of frame” signal. The process is the same when performed by the second SATSI stage 22.

FIG. 4A illustrates the buffer loading process that is performed when a path through the SATSI is operating in asynchronous mode. At step 450 the “start of channel” signal generated by the clock 155 is detected by the control circuitry 68, and the process is triggered to start. At step 460, the control circuitry 68 causes the content of this port's input buffer 56-64, which will be a single cell of data, to be copied to this port's switching buffer 160-168. At step 470 control circuitry 68 deletes the cell from the input buffer 56-64. At step 475 control circuitry 68 generates a “Switching Buffer Ready Signal”, which triggers the SATSI time-slot interchange switching process (see FIG. 7) to start for the single-flow packet buffer into which cells of the asynchronous packet stream are being buffered. Control then stops the process until it is triggered by the next “start of frame” signal. The process is the same when performed by the second SATSI stage 22.

FIG. 5 illustrates steps taken in an asynchronous mode of operation of the SATSI 16.

A “single-flow packet buffer written to” signal is generated by the time-slot switching process each time a cell is written to any single-flow packet buffer (see FIG. 7). This signal is detected by the control circuitry 68 and the asynchronous mode is triggered to begin for a particular single flow packet buffer. To prevent the process illustrated in FIG. 5 being restarted by another “single-flow packet buffer written to” signal before it has stopped 560, this signal is disabled 515, and re-enabled at the end of the process 555. At step 520, control circuitry 68 uses a packet-framing process specific to a particular packet protocol to identify a packet frame in the buffer starting from the front. If there is none, the “single-flow packet buffer written to” signal is re-enabled (see step 555), the process temporarily stops 560.

If a properly-framed packet can be identified in the buffer, the control circuitry 68 checks that it is valid according to the specific packet protocol (see step 525). For example, this might include checking the packet's checksum. If it is not, it is discarded (see step 530), the “single-flow packet buffer written to” signal is re-enabled (see step 555), and the process stops (see step 560).

If the packet is valid, the control circuitry 68 looks up in the packet buffer interface table the interface identifier for this single-flow packet buffer, and copies the packet to each multiple flow packet buffer associated with this interface (see step 540). Multiple-flow packet buffers operate prioritization and discard policies appropriate to their specific packet protocol, as described hereinbefore.

At step 550, the control circuitry 68 deletes from this buffer the packet and any cells that precede it, since they cannot be properly framed. The “single-flow packet buffer written to” signal is re-enabled 555. Control process then stops 560 until retriggered by the next “single-flow packet buffer written to” signal (see FIG. 7). The process is the same when performed by the second SATSI stage 22.

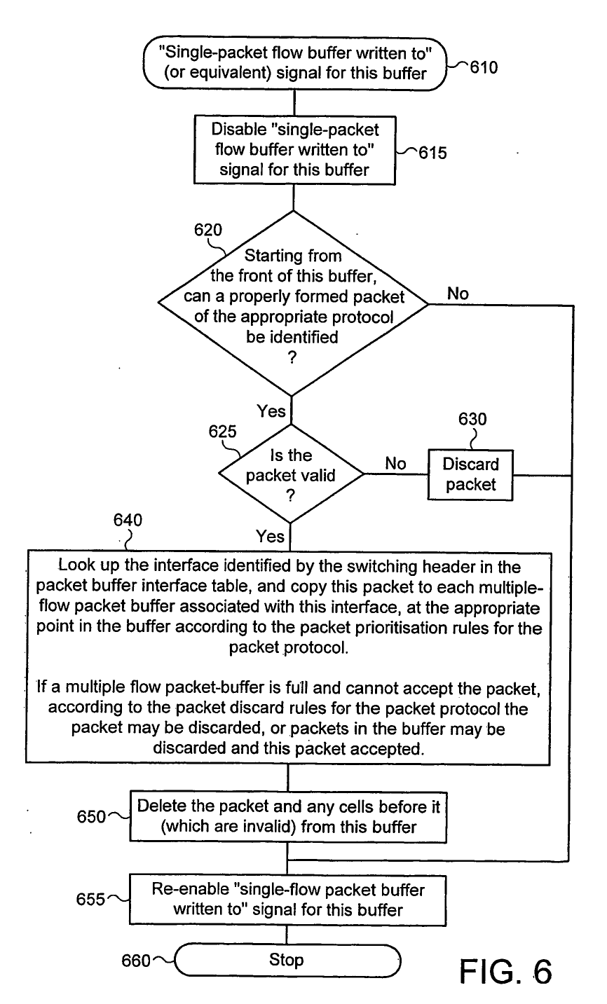

FIG. 6 illustrates steps performed in a packet switching mode of the SATSI 16. Thus, this mode of operation tends to be used most frequently by the second SATSI stage 22. It corresponds to the asynchronous mode of operation of the SATSI apart from the packet framing process (see step 620) which identifies packets formatted for packet switching, whose header (and perhaps trailer) identify the egress interface to which their payload is to be forwarded, and in addition such information as payload prioritization and discard eligibility.

A “single-flow packet buffer written to” signal is generated by the time-slot switching process each time a cell is written to any single-flow packet buffer (see step 745 of FIG. 7). This signal is detected by the control circuitry 104 and the asynchronous mode is triggered to begin for a particular single flow packet buffer. To prevent the process illustrated in FIG. 6 being restarted by another “single-flow packet buffer written to” before it has stopped 660, this signal is disabled 615, and re-enabled at the end of the process 655. At step 620, control circuitry 104 uses a packet-framing process specific to a particular packet protocol to identify a packet frame in the buffer starting from the front. If not, the “single-flow packet buffer written to” signal is re-enabled (see step 555), then the process temporarily stops 660.

If a properly-framed packet can be identified in the buffer, the control circuitry 104 checks that it is valid according to the specific packet protocol (see step 625). For example, this might include checking the packet's checksum. If it is not, it is discarded (see step 630), the “single-flow packet buffer written to” signal is re-enabled (see step 555), and the process stops (see step 660).

If the packet is valid, the control circuitry 68 looks up in the packet buffer interface table the interface identifier that is contained in the switching header, and copies the packet to each multiple-flow packet buffer associated with this interface (see step 640). Multiple-flow packet buffers operate prioritization and discard policies appropriate to their specific packet protocol, as described hereinbefore.

At step 650, the control circuitry 104 deletes from the buffer the packet and any cells that precede it, since they cannot be properly framed. The “single-flow packet buffer written to” signal is then re-enabled 655. Control process then stops 660 until retriggered by the next “single-flow packet buffer written to” signal (see FIG. 7). The process is the same when performed by the second SATSI stage 22.

With reference in particular to FIG. 7, the time-slot interchange switching process performed by the SATSI stages 16 and 22 will now be described in more detail. The process switches cells from input channels to output channels in a buffer, either an output buffer 181, 183, 185, 187, 189 or a single-flow packet buffer.

At step 710, the control circuitry 68,104 detects the “switching buffer ready” signal generated by the control circuitry once every frame for each switching buffer whose port is synchronous mode (see FIG. 4), and once every time slot for each switching buffer whose port is in asynchronous mode (see FIG. 4A), as each cell is transferred from the input buffer port's input buffer. In response, the output channel pointer is initialized to start at the beginning of the switching table (see step 715). In the example of FIG. 3 the pointer for signal path #1 begins at address space 11,000.

At step 720, the control circuitry 68,104 accesses the switching information 210 to determine the source input channel for the output channel in question. At step 725, the cell that is currently buffered for this input channel (in either a switching buffer or a multiple-flow packet buffer) is read. At step 730, control circuitry 68,104 checks to see if the buffer is already full. If it is not, this cell is copied to the output buffer (see step 735), this buffer location corresponding to the output channel. Control circuitry 68,104 then checks if this output buffer is a single-flow packet buffer. If it is, control circuitry 68 generates a “single-flow packet buffer written to signal” (triggering the start of either an asynchronous mode or packet switched mode process for that buffer). In either case, or if the output buffer is full, the process continues at step 750.

Control circuitry 68,104 then checks if the input channel addresses a multiple-flow packet buffer (see step 750). If it does, the leading cell of that buffer is deleted 755, so that what was the second cell becomes the first. Next the output channel pointer is incremented by 1 (see step 760). If the process has not reached the last pointer in the output channel it reverts to step 720 (see decision indicated by reference numeral 765). If the last pointer in the switching table has been processed, the control circuitry 68,104 halts the process as indicated at step 770.

In use, the signal streams received by and output from the line interface units 42-50 pass into the first signal path switching stage 15. Switches SW1-SW5 are set to direct the signal streams either directly to the switches SW6-SW10, or through the switching fabrics of SATSI 16 and 22. These use switching tables which are programmed to deliver predetermined logical links through the network and, where appropriate, reassemble packets for packet processing via packet buffers. High QoS synchronous streams output from the SATSI switching stage 16 may be switched to decoding circuitry 53,55 and, via line interface units 49,50 to, for example, a phone, a digital audio player, a video monitor, etc. or onto one of the direct links 86-90 through the node, whereas output streams from multiple-flow packet buffers are switched onto an appropriate one of the packet processing pipelines 82,83.

High QoS traffic arrives at one of the switches SW11-SW15 of the second SATSI stage 22 and may be switched directly to the corresponding switch SW16-SW20 if no further multiplexing/demultiplexing is required for the stream, or switched through the SATSI stage 16 if further multiplexing/demultiplexing is required. Thereafter the traffic is supplied to a respective one of the egress line interface units 116-124.

At the same time, packets switched by the first SATSI stage 16 onto respective ones of the packet processing pipelines 82,83 are processed as appropriate to the network protocols implemented by them. As explained hereinbefore, packet processing pipelines need not implement all layers of the OSI stack.

In this embodiment, stages 82a-82d of pipeline 82 implement a packet processing pipeline for an OSI layer 3 network protocol operating over an OSI layer 2 link layer protocol, for example, IP over Ethernet. Stages 83a and 83b of pipeline 83 implement an OSI layer 3-only packet processing pipeline. This enables OSI layer 3 traffic to be carried without using OSI layer 2 link layer mechanisms. There are many other examples of useful pipelines which an be used in accordance with the present invention.

Stages 82d and 83b prepends packet switching information in the form of a switching header to the packet issuing from stages 82c and 83a respectively of the packet processing pipelines. This switching information includes an interface identifier which identifies the egress interface to which their payload is to be forwarded, and in addition such information as payload prioritization and discard eligibility.

The interface corresponds to a set of multiple-flow packet buffers, as specified in the packet buffer interface table, and packets forwarded to a given interface are copied to each multiple-flow packet buffer. Multiple-flow packet buffers prioritize or discard this packet according to the rules of the specific packet protocol.

Input ports for paths #1 and #2 of the second SATSI stage 22 are in packet switch mode, and signal path switches SW11 and SW12 are set up to switch signals into the input buffers 92,94. The packet (less any switching information added by the packet processing pipelines) is copied to the set of multiple-flow packet buffers corresponding to the interface, as determined by the packet buffer interface table. The multiple flow packet buffers are switched by the SATSI switching stage 102 according to the pre-programmed switching tables onto selected ones of the SATSI output buffers 106-114 for supply onto the line interface cards 116-124.

With reference to FIG. 9, logical links are built at the request of network managers, users, or software or hardware processes. In this embodiment a request to build a logical link can minimally specify the start and finish of the link, the bandwidth of the link and the class of traffic that the logical link is to carry. Some of these parameters might have defaults in certain networks.

Setting up a logical link is a distributed process which occurs in two passes, an outbound pass and an inbound pass. On the outbound pass, a request to establish a logical link is routed from a source node to a destination node over a plurality of preferred nodes. A record of the route undertaken is constructed during the pass and retained as part of the request data, and each node checks to establish whether or not the node can make the required resources available. If the node does have the required resources available, it sets up the logical link and appropriate switching tables. If the request reaches its origin without being denied, the logical link has been established and is ready for us. A message is sent halting further searching for resources.

If at any each node, insufficient resources are available, the node returns a request denied message to the node from which the request arrived. Protocol handlers at that node may then try alternative routes via other preferred nodes connected to this node. In this way, the entire tree of possible routes can be tested for paths with suitable resources.

Another embodiment is able to provide low latency data transport between any two end points in the network is described below. These end points may comprise of computers or routers or any consumer device such as telephone or an Internet appliance.

The network consists of nodes which are connected to each other using a plurality of distinct channels. Each node has the ability to provide a number of dedicated channels, each channel comprising of an input medium which can be switched through to an output medium by means of management software. Once a channel has been set up through a particular node, all traffic through that channel is switched in the form of serial data, resulting in the extremely low latency characteristics of the network.

Dedicated channels such as described above may then be constructed spanning more than one node in the network. At the end points of these channels, the node responsible for constructing the channels will accept and provide communications traffic by means of, for example, an Internet Protocol router function. Where the end point node is located in a consumer premises, the router interfaces to a separate channel between the router and the consumer electronic appliance, for example a voice over internet protocol telephone. Where the end point node is located close by, for example an Internet Point of Presence, the router will interface to a high bandwidth switch or router which is connected to low latency backbone media. In this manner traffic can be routed globally with extremely low latency from consumer device to consumer device.

One such implementation of the network could make use of wireless links for the channels between the nodes. Wireless could also be used for connecting the router at the consumer premises to the electronic appliances used by the consumer in close proximity to one or more such network nodes.

When using unreliable media such as wireless, more than one channel may be set up for a single purpose in order to provide redundancy of the signal. In the event where one channel suffers data corruption en-route, another channel which follows a separate geographical route to the same destination node may not be corrupted en-route. In this manner reliable transport can be provided even while using unreliable media.

The nodes set up distinct transmit channels for outgoing communication requirements. The return paths or receive channels are built by the destination node in response to the request for communication services. In this manner the receive and transmit channels occupy unrelated paths.

The network does not rely on legacy telecommunications infrastructure such as telephone exchanges and Internet Service Providers The network can be used in complete isolation from any existing data networks or telephony networks. In this case any consumer who has a node installed in their home and is part of a network of nodes in nearby buildings and homes an engage in peer to peer connectivity with any other member of the network in their local area.

In the case where it is desirable to connect two or more isolated areas, this can be accomplished by making use of existing low latency backbone, such as provided by optical fiber. The network enables peer to peer telecommunications on a very large scale. For example, any consumer could connect a Voice over Internet Protocol telephone to their node, and using this telephone, would be able to place a telephone call to any other consumer who also has a Voice over Internet Protocol telephone connected to their node. There are no significant running costs for this service, each consumer provides a safe place for the network node and pays the electricity bill for his own node.

In the case where a consumer with a node and an Internet appliance wishes to engage in Internet Protocol traffic with another user who relies on legacy means of telecommunications infrastructure such as a wired telephone or a dial up Internet connection using some form of traditional local loop access such as copper, cable of fiber, the Internet backbone provider will be able to route the traffic in the appropriate manner using Voice over Internet Protocol Gateways and collect any legacy call termination charges. The charges can be passed on to the consumer in a number of ways such as pre-paid calling cards.

The network enables a consumer to take their Voice over Internet Protocol handset and use it at their neighbor's node. Since there is no billing associated with the use of the node, there is no requirement to tie a user down to a particular node for low bandwidth services such as Short Message Services, email, telephony amongst others.

In the case where a consumer travels abroad, their Internet Appliances will work equally well in any geographic location which has a network of nodes connected to backbone. This may be achieved by utilising one or more telecommunications standards commonly in some or all nodes for the link to consumer electronic appliances, while utilising various telecommunication standards for node to node data communication. This would enable the systems to comply with telecommunications standards in different territories, while at the same time providing global consumer electronic device interoperability.

The use of, for example, Domain Name Services could provide for the resolution of hostnames to IP addresses for the network. Where a user roams to another territory, such Domain Name Services could be updated dynamically in order to ensure the reachability of the consumer regardless of which isolated collection of nodes they are close to.

The above services may be built into the network in order to decrease reliance on legacy telecommunication systems. Other services, include, for example, Email, Short Messaging Services and firewalling may also be built into the nodes. Most of these services may be dispersed over a number of nodes in order to provide carrier levels of availability for the services.

In the case where wireless media is used, efficient means of spectrum use and re-use may be applied. Separate transmit and receive antennae may be used in order to maximise the usable signal between two nodes.

The pre-emptive setting up of channels between nodes will result in a lower end to end protocol overhead, leading to greater throughput compared to legacy wireless Local Area Network equipment.

Geographic areas which have been difficult or prohibitively expensive to provision connectivity can be provisioned when wireless media is used as long as there is clear Line of Sight between participating nodes and their closest neighbours. In this manner high bandwidth connectivity can be provided using very short wireless links between a large number of nodes.

The network can be built in a psuedo random manner by choosing an area such as a particular suburb. A small number of nodes can be installed in order to seed such a suburb, spread out over the area. Thereafter any consumer who decides to place a node in their premises may do so. Each consumer adding a network node increases both the bandwidth capacity of the network along with the switching capacity and service capacity, such a Domain Name Service, email service and others.

The network could provide fully encrypted Internet Protocol traffic between nodes. Trusted parties such as government agencies may require the encryption keys in order to allow wiretapping. Wiretapping can be accomplished by means of, for example, Internet Protocol Multicasting.

A means of identifying a consumer may be built into consumer electronic appliances in order to limit abuse of the network. Any number of means of identity may be used such as a Personal Identification Number or biometric means.

In summary, preferred embodiments thus provide the foundation for a multiservice switching architecture. The architecture supports and extends all existing packet- and circuit-switched network architecture. Transport can be reconfigured to the optimal combination of packet- and circuit-switching at any given point in time. That is, circuit switching has zero contention, zero congestion, low latency, in-order delivery of packets, zero packet loss and negligible jitter, whereas packet switching benefits from statistical multiplexing, always-on availability and ease of adoption of service innovations.

Preferred devices also enable layer 1 interworking between different networks. Advantageously, control over switching resource partitioning enables multiple logical networks of different types to operate over the same physical network infrastructure (e.g. a LAN, a WAN, a SAN, etc.). Further, preferred devices also enable application of valuable network processing resources to be optimised. In addition, the need for tunneling, encapsulation, conversion etc. is reduced and/or eliminated. Multicast transport of unpacketised, streaming data is also supported by preferred nodes.

Those skilled in the art will recognise that the present invention has a broad range of applications and can operate over any known communications media carrying many different communications protocols. The various embodiments admit of a wide range of modifications, without departure from the inventive concept. For example, specific hardware and software configurations or arrangements described herein are not intended to be limiting. Components defined in hardware can be implemented for example as portions of general purpose computers, special purposes computers, program microprocessors or microcontrollers, hardware electronic or logic circuits such as application specific circuits, discrete element circuits, programmable logical devices or the like. Components implemented in software could be implemented in any known or future developed program languages. Further, aspects implemented in hardware could equally be implemented in software, and vice versa.

1. A communications node for establishing a plurality of logically distinct communications links running through the node contemporaneously to one or more remote nodes, the communications node comprising: input switch means; output switch means; a plurality of communications resources connected between said input and output switch means, said plurality of communications resources including at least first and second communications resources adapted to deliver different communication services including packet-switched and circuit-switched services; control means associated with said input switch means and said output switch means to establish logically distinct links through the node, wherein each said link is configurable to selectively include one of the at least first and second communications resources.

2. A communications node as in claim 1, wherein said communications resources include signal processing means.

3. A communications node as in claim 1 or 2, wherein said communications resources include packet processing means.

4. A communications node as in claim 1, wherein said communications resources include a first plurality of communications resources adapted to serve one of said service types and a second plurality of communications resources adapted to another of said service types.

5. A communications node as in claim 1, wherein the at least first communications resource is arranged to process a component of a synchronous input signal, and the at least second of said communications resources is arranged to process a component of an asynchronous input signal.

6. A communications node as in claim 1, wherein a plurality of packets from a signal flow is processed by said second communications resource.

7. A communications node as in claim 1, wherein said input switch means is arranged to receive at least one input signal partitioned such that it comprises a plurality of signal components, wherein said plurality of logically distinct links through the node are established by means of logically associated ones of the signal components.

8. A communications node as in claim 7, wherein said output switch means is configurable to receive signal components and switch said signal components onto at least one output signal which partitions said signal components, wherein said logical links through the node are extended by means of logically associated ones of the components of the output signal.

9. A communications node as in claim 7 or 8, wherein said signal components are partitioned by means of one or more of: time division multiplexing; frequency division multiplexing; code division multiplexing; and space division multiplexing.

10. A communications node as in claim 7 wherein said input switch means is configurable to switch a plurality of partitioned input signals contemporaneously.

11. A communications node as in claim 7, wherein said output switch means is configurable to switch a plurality of partitioned output signals contemporaneously.

12. A communications node as in claim 1, wherein one or more of said logical links spans more than two nodes such that it establishes a logical network.

13. A communications node as in claim 12, wherein one or more of said logical networks is initiated and/or terminated at a node.

14. A communications node as in claim 12, wherein one or more of said logical networks is initiated and/or terminated at an end terminal.

15. (canceled)

16. (canceled)

17. A communications node as in claim 12, wherein said input switch means and said output switch means are configurable to circuit switch communications data on a logical link such that low latency transfer of said data is achieved.

18. A communications node as in claim 12, wherein pluralities of said logical links are programmably aggregated and disaggregated by said node.

19. A communications node for receiving at least one input signal comprising a plurality of components, each said component comprising part of a logical link over a portion of a communications network, the communications node comprising: ingress means for receiving said at least one input signal; egress means for outputting at least one output signal comprising one or more components of said input signal; one or more signal processing means connected between the ingress means and egress means, for receiving components of said at least one input signal and processing said components in accordance with a predetermined communications process; first switching means configurable to selectively cause a signal output from said ingress means to bypass one or more of said signal processing means en route to said egress means; second switching means configurable to direct signals output from said signal processing means to said egress means.

20. A communications node as in claim 19, wherein said first switching means is configurable to provide a connection between said ingress means and said second switching means, which connection bypasses all of said signal processing means.

21. A communications node as in claim 19 or 20, wherein there is provided a plurality of signal processing means connected between said ingress means and said egress means, each one of said plurality of signal processing means being arranged to receive at least components of said at least one signal and to process the received components in accordance with a predetermined communications process.

22. A communications node as in claim 21, wherein first and second ones of said plurality of signal processing means are arranged to process received components in accordance with a different predetermined communications process.

23. A communications node as in claim 21, wherein different ones of the signal processing means are arranged to process signal components at one or more layers selected from layers 1,2, 3,4, 5,6 and 7 of the open systems interconnect model.

24. A communications node as in claim 21, wherein said first switching means is configurable to supply a component of the at least one input signal to a first signal processing means and another component of the at least one input signal to a second signal processing means.

25. A communications node as in claim 19, wherein the timing of an input signal is synchronous with a timing reference signal of the node.

26. A communications node as in claim 19, wherein an input signal is time division multiplexed such that said components are a plurality of time slots, corresponding time slot defining part of a logical link.

27. A communications node as in claim 26, wherein frame pulses occurring at redefined timing intervals delimit a number of time slots to be buffered and/or switched between frame pulses.

28. A communications node as in claim 25, wherein a plurality of synchronous input signals are received at said ingress means and said output signal from said egress means comprises components from different ones of the input signals.

29. A communications node as in claim 19, wherein the second switching means supplies a plurality of output signals to said egress means, and wherein first and second output signals of the plurality of output signals comprise components from one input signal.

30. A communications node as in claim 19, wherein the rate of receipt of an input signal is independent of a timing reference signal of the node.

31. A communications node as in claim 30, wherein an input signal comprises packets.

32. A communications node as in claim 19, wherein at least one processing means comprises a packet processing pipeline.

33. A communications node as in claim 32, wherein said second switching means is arranged to switch a packet supplied from the packet processing means in accordance with destination information associated with the packet by the packet processing means.

34. A communications node as in claim 32, wherein a packet from an input signal is switched such that it appears as a packet in a plurality of output signals of the egress means.

35. A communications node as in claim 32, wherein a plurality of packet flows each on a different logical link of an input signal are switched such that they appear as packet flows on different output signals of the egress means.

36. A communications node as in claim 31, wherein a plurality of packet flows on a logical link of first and second input signals are switched such that they appear as packet flows on different logical links of an output signal of the egress means.

37. A communications node as in claim 31, wherein a plurality of packet flows on a logical link of an input signal are switched such that they appear as packet flows on logical links of different output signals of the egress means.

38. A communications node as in claim 31 or 32, wherein an input signal comprises packets belonging to a plurality of packet flows each packet flow being carried on a different logical link, wherein said first switching means is operable to demultiplex the input signal to provide individual packet flows and supply a combined packet flow therefrom to an appropriate packet processing pipeline for processing in accordance with a predetermined packet processing protocol.

39. A communications node as in claim 31 or 32, wherein said second switching means is programmed with switching information such that it receives packets from said first switching means which have bypassed said packet processing means and directs them without reference to destination information in the packet.

40. A communications node as in claim 19, wherein said at least one input signal comprises a first input signal which is timed synchronously with a timing reference signal of the node and a second input signal having a rate of receipt independent of said timing reference signal of the node.

41. A communications node as in claim 40, wherein said at least one input signal comprises a first plurality of input signals timed synchronously with a timing reference signal of the node and a second plurality of input signals having a rate of receipt independent of said timing reference signal of the node.

42. A communications node for receiving and transmitting signals comprising sets of signal components transmitted at intervals, wherein a set comprises a number of signal components partitioned from one another and wherein concatenated signal components in adjacent sets establish a number of logical links over a portion of a communications network, said node comprising: input switch means; output switch means; control means connected to said output switch means and programmable to cause selected ones of the partitioned signal components of a set to be aggregated, such that said aggregated signal components define an aggregated logical link having a bandwidth corresponding to a predetermined multiple of the signal component bandwidth.

43. A communications node as in claim 42, further comprising control means connected to said input switch means and programmable to cause partitioned signal components which have been aggregated at a remote node to be disaggregated.

44. A communications node as in any of claims 42 or 43, further comprising a plurality of signal processing means connected between said input switch means and said output switch means, wherein said input switch means is configurable to supply at least a component of an input signal to a selected one of said signal processing means.

45. A communications node as in claim 44, wherein one or more of said node processing means is arranged to process at least a signal component received on an aggregated logical link after signals transferred thereto have been disaggregated.

46. A communications node as in claim 44, wherein one or more of said node processing means arranged to process at least a component of a signal received on an aggregated logical link without disaggregating the partitioned signal components defining the aggregated logical link.

47. A communications node as in claim 44, wherein at least one signal processing means is arranged to support one or more of Ethernet, ATM, IP, IP over ATM, IP over Ethernet or unpacketised data.

48. A method of setting up a logical link across a portion of a network comprising
providing a plurality of communications nodes for establishing a plurality of logically distinct communications links running through the node contemporaneously to one or more remote nodes, the communications node including: input switch means; output switch means; a plurality of communications resources connected between said input and output switch means, said plurality of communications resources including at least first and second communications resources adapted to deliver different communication services including packet-switched and circuit-switched services; control means associated with said input switch means and said output switch means to establish logically distinct links through the node, wherein each said link is configurable to selectively include one of the at least first and second communications resources; and
routing a request to establish a logical link from a source node to a destination node over at least one of the plurality of communications nodes.

49. A method of setting up an aggregated logical link, comprising:
providing a plurality of communications nodes for receiving and transmitting signals comprising sets of signal components transmitted at intervals, wherein a set comprises a number of signal components partitioned from one another and wherein concatenated signal components in adjacent sets establish a number of logical links over a portion of a communications network, said node comprising: input switch means: output switch means; control means connected to said output switch means and programmable to cause selected ones of the partitioned signal components of a set to be aggregated, such that said aggregated signal components define an aggregated logical link having a bandwidth corresponding to a predetermined multiple of the signal component bandwidth; and
routing a request to establish a logical link from a source node to a destination node over at least one of the plurality of communications nodes.

50. A method of setting up a logical link across a portion of a network comprising:
providing a plurality of communications nodes for receiving at least one input signal comprising a plurality of components, each said component comprising part of a logical link over a portion of a communications network, the communications node comprising: ingress means for receiving said at least one input signal; egress means for outputting at least one output signal comprising one or more components of said input signal; one or more signal processing means connected between the ingress means and egress means, for receiving components of said at least one input signal and processing said components in accordance with a predetermined communications process; first switching means configurable to selectively cause a signal output from said ingress means to bypass one or more of said signal processing means en route to said egress means; second switching means configurable to direct signals output from said signal processing means to said egress means; and
routing a request to establish a logical link from a source node to a destination node over at least one of the plurality of communications nodes.
